(19) United States
(12) Patent Application Publication
(10) Pub. No.: US 2013/0061257 A1
(43) Pub. Date: Mar. 7, 2013

(54) VERBALLY COMMUNICATING FACIALLY RESPONSIVE TELEVISION APPARATUS

(71) Applicant: NORIFUMI TAKAYA, SAN DIEGO, CA (US)

(72) Inventor: NORIFUMI TAKAYA, SAN DIEGO, CA (US)

(73) Assignee: SONY CORPORATION, Tokyo (JP)

(21) Appl. No.: 13/224,577

(22) Filed: Sep. 2, 2011

(51) Int. Cl. H04H 60/33

(52) U.S. Cl. 725/10

(57) ABSTRACT

A television apparatus for generating personalized verbal outputs in response to identifying individual viewers. A camera and image/facial recognition subsystems are configured to identify individuals and retrieve stored information for use in generating personalized verbal outputs to the viewers.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to television sets, and more particularly to a television which verbally communicates with users in response to facial recognition.

2. Description of Related Art

Users rely on television sets within their homes for watching the news, movies, shows, and so forth. In view of its uses, television sets have become increasingly large and have achieved a central position within many homes.

However, televisions largely remain passive devices that must rely on direct or remote control inputs. In addition, the television devices remain impersonal to their users who are viewing them.

Accordingly, the present invention provides an enhanced personalized television experience, while overcoming shortcomings of previous television control apparatus.

### BRIEF SUMMARY OF THE INVENTION

The television apparatus taught in the present invention verbally communicates with the user in a personalized conversational manner. This communication is performed in response to image information collected by a camera coupled to a computer within the television which performs image processing (e.g., including facial recognition) to identify individual viewers and groups of viewers that are proximal the television. The system does not merely determine if persons are present near the television device, but actually determines the identification of these people and interoperably utilizes this information toward generating personalized verbal output.

In response to determining the identities of these individuals and looking up information on their respective sets of preference and viewing history, personalized verbal annunciations are generated, whereby the television ‘talks’ with these individuals to provide useful information and in some cases ‘chatter’. The word ‘chatter’ is used in the present invention to mean verbal output which may wholly lack information content, while eliciting some feelings by the user of personal interaction.

Personal (individual) recognition permits a level of audio interaction between the television and the viewer which was not previously available. Based on recognition of individual and/or groups of individuals, a customized status and set of preferences may be tailored for each user, or combination of users. Moreover, the verbal output of the television is not restricted to merely status, but also embodiments of the invention can provide specific verbal alerts about things of interest to that specific viewer, including information about shows of expected interest (e.g., viewing times and channels, background information), weather conditions, news, and even in certain embodiments the availability of incoming email, appointment dates, and so forth. The verbal outputs are generated in a manner that makes them personal and conversational based on contexts, templates and heuristics which utilize information from preference settings for the identified individuals.

Although certain implementations of the inventive television system may obtain external information for the benefit of identified individuals and groups, it does not require implementation of a separate computer server, although it can be configured to cooperate with one.

The present invention provides a number of beneficial elements which can be implemented either separately or in any desired combination without departing from the present teachings.

Further aspects and embodiments of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of a television apparatus according to an embodiment of the present invention, showing a computer and memory within the apparatus.

FIG. 2 is a flow diagram of verbal communications by a television configured with facial recognition according to an embodiment of the present invention.

FIG. 3 is a flow diagram of verbal communication selection according to an embodiment of the present invention.

FIG. 4 is a flow diagram of optional verbal recognition by a television configured according to an embodiment of the present invention.

### DETAILED DESCRIPTION OF THE INVENTION

The television apparatus according to the invention provides a novel verbal communication ability which is specific to individual viewers and groups. This ability to ‘talk’ with specific users allows the TV to provide customized information to each user, and it can make the television experience more personalized, informative, entertaining and friendly.

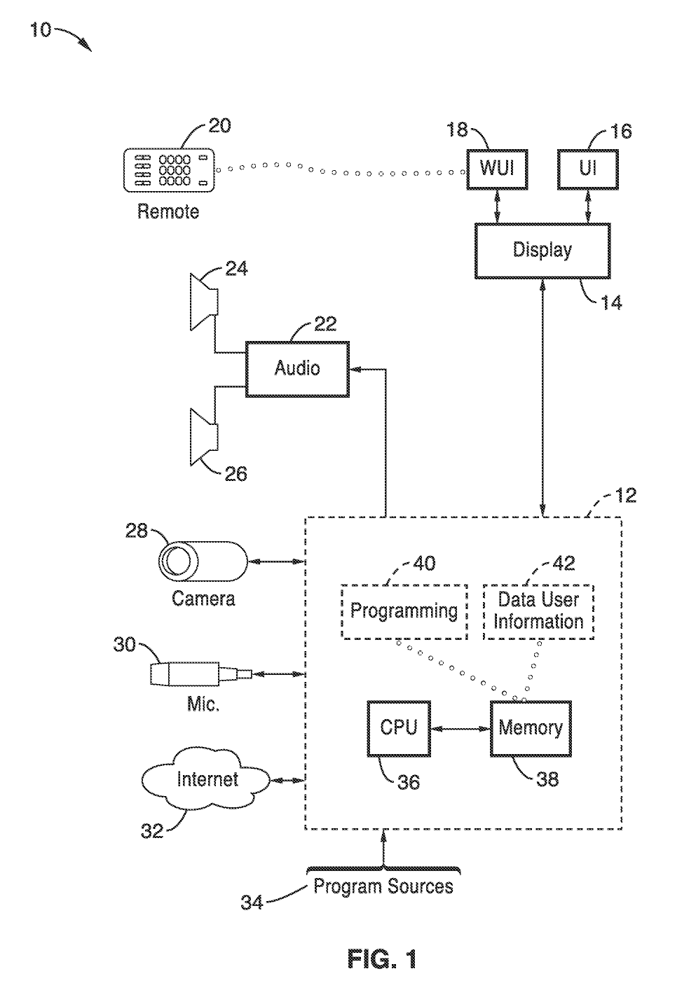

FIG. 1 illustrates an example embodiment 10 of a verbally responsive television set apparatus which operates in response to image recognition, and more preferably facial recognition. A control subsystem 12 controls a number of input and output devices, including at least one television display 14, user interface devices represented by a manual (tactile) user interface 16, wireless user interface 18 and associated remote control 20. Verbal output is configured for generation over an audio subsystem 22 having audio annunciators (speakers), and preferably at least two such annunciators/speakers 24, 26 to provide stereo output.

An image capture device 28 is shown configured for capturing still images and/or video images proximal the television apparatus. For the sake of simplicity, and not of limitation, the camera is shown without external lighting, variable focusing or zooming elements. It will be appreciated that any form of enhanced camera features can be supported. In one embodiment of the invention, the television provides an infrared light source (e.g., one or more elements, such as light-emitting diodes (LEDs), for instance in a ring configuration about the lens of the camera. The inclusion of infrared lighting in certain embodiments of the invention, allows for reliable operation of the image/facial recognition subsystem even in low ambient lighting situations which are common during television viewing. In one mode of the invention, the programming is configured to perform image/facial recognition in response to light output from the display and to automatically compensate for color and intensity levels based on the color, patterns and intensity output from the television display, thus correcting the collected image patterns. Compensation may be performed for example utilizing averaging mechanisms (e.g., across frames with different color outputs), utilizing known color correction mechanisms, or other known means to provide sufficiently accurate identifications.

An optional microphone 30 is also shown, to support verbal recognition according to at least one embodiment of the present invention. In addition, an optional wide area network interface 32 is shown, such as for providing connectivity to the Internet which is utilized automatically, without user intervention, by the verbal response mechanisms of the present invention. As with any television, it is capable of receiving media information from a variety of program sources 34, such as from set-top boxes (STB), cable inputs, video players, over-the-air (OTA) programming, and other media sources.

Control subsystem 12 of the television apparatus includes at least one computer processing element, depicted as a central processing unit (CPU) 36 coupled to memory 38 for storing programming 40 executable on processor 36, as well as data 42 including user information, image recognition patterns, selection preferences, and other desired data. It will be appreciated that elements of the present invention can also be implemented as programming stored on a media and configured for use within a television apparatus having an associated image capture device.

The television set is configured with a camera 28 for capturing images to perform recognition of individuals and groups to which a set of selection preferences are associated, so that upon identifying the individual through image/facial recognition their respective preference settings and history can be retrieved (looked up). By way of example and not limitation, the television can provide a setup process which directs users to enter their respective preferences and directs the user in view of the camera so that the image recognition information can be associated with the preferences set by the user, including their name. It will be appreciated that the television preferably outputs video from the camera during this process to provide user feedback. During this identification process the system performs image recognition, preferably prominently including facial recognition, with recognition data (e.g., point sets, feature sets, recognition templates or other descriptors according to available recognition algorithms) being stored for later use.

It will also be appreciated that during other processes and circumstances “unknown” users can be correlated with their viewing history information by the system. For example, in one mode the system captures images for unknown parties whose name and preference data has not been entered in association with their captured image data. The system attaches a temporary handle (name) to each, selects a default set of preferences, and stores the data. If an individual is recognized as being one of these unknown persons, then the default preferences and viewing history for this individual are still available for use in personalizing verbal response by the system. It should be appreciated that the system is preferably configured to store viewing history, (e.g., shows, times, types and so forth) even for viewers which have not specifically entered their preference information and name. This information can be utilized to personalize the verbal output, even without knowing the name to include in the verbal output. At some point, such as if the same individual repeatedly uses the television a given number of times, they can be asked if they want to select their verbal communication preferences.

During operation, the television set captures images of the proximal viewing area and performs image-facial recognition and executes a lookup to determine who is present and to obtain their preference settings, history data, and other information stored for this individual. Additional data (external data) can be obtained, for example through the wide area networking connection (e.g., connecting to the Internet), such as program guides with shows, times, and channels, weather information, news, and other information as available.

The television can verbally communicate to one or more individuals, such as “welcome back Jacob”, or “Hey Bob—Masterpiece Theatre is coming on in ten minutes on channel 12”, or “Ned—its nearly 8 PM”, or “your favorite actor ‘Tide Cleave’ is featured in a movie ‘Forging a Fickle Stream’ in 33 minutes on channel 4”. Additionally, the verbal output may comprise friendly ‘banter’, such as upon the user selecting an input from a DVD player the TV saying “are you going to watch a movie? I hope it's a good one”. This could be extended such as “Tonight is a full moon—might be a good night for a thriller.”; based on obtaining date almanac data through the internet.

It should be appreciated that the verbal output is customized to the particular user in regards to their preference settings, viewing history (e.g., favorite shows, viewing days, times, genre, and so forth), and to additional information, weather, news, information of interest about different shows and any other information that the user has expressed interest in within the preference setting or by communication to the television and that is available for communicating to the user.

In the present invention the television provides a desired degree of chatter based on information collected which relates to the user's interests including, but is not limited to history (usage), connections, presence, actions, of and by the user to maximize the viewing experience in a friendly atmosphere.

In addition, many TV viewers live alone or use their TV to provide ambiance within their home. Some of these users may appreciate or enjoy it if their TV appears to communicate with them. Since not all users would want a “gabby” television, embodiments of the present invention allow the user to select the extent and nature of verbalizations, such as selecting these within the preference settings.

In one embodiment of the invention, the chatter mode is preferably configured to detect conditions, at least user proximity, as well as user viewing history, and can optionally collect additional information. The chatter mode is configured according to at least one device embodiment to provide some degree of random selection of chatter context and phrasing, so that the chatter is not wholly predictable.

In optional embodiments, the verbal (chatter) mode can register input from the user, such as gestures which are registered in response to image recognition, and/or utilizing speech recognition through microphone 30.

One of ordinary skill in the art will recognize that the elements of the present invention described above may be implemented in alternative ways without departing from the invention. Accordingly, the present television device can be described as a plurality of means elements operating cooperatively for the television to respond to image recognition, and more preferably facial recognition, as described by the following in relation to FIG. 1. A means for controlling the television 12 provides for control of displaying video images and generating of audio output. A means is provided for displaying video images 14 to the user, while a means for collecting user input is provided for collecting direct user input (e.g., tactile) input 16 and/or user input over a wireless connection 18, such as from a remote device 20. A means for generating audio output 22 is provided through which the system can generate verbal output. A means for capturing images 28 allows the television to operate for capturing still images and/or video images proximal the television apparatus. The television is configured with a means for receiving media content 34 for output on the television. Optionally, the television apparatus comprises means for performing verbal recognition 30 on verbal input from the user, wherein audio input is audio processed by control means 12 for recognizing verbal input from the user. A means is preferably included for establishing connection 32 with a wide area network, such as the Internet.

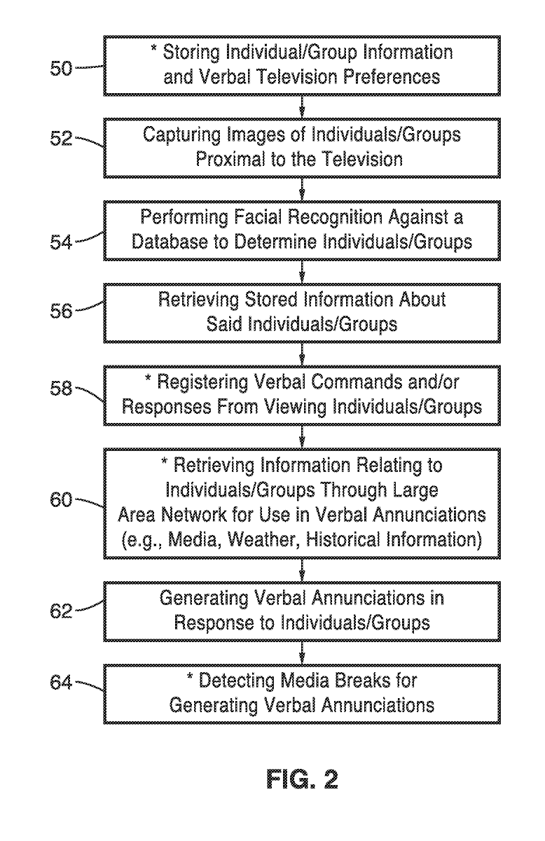

FIG. 2 illustrates an example embodiment of the verbal communications method according to the invention. In at least one embodiment of the invention preferences are stored 50 for one or more individuals (or groups). Step 50 is marked with an asterisk in FIG. 2 to denote it as an optional step along this series of method steps, as preferences can be stored in various ways and times without departing from the teachings of the present invention. Preference settings describe how the verbal communications are to be processed in the system for each individual (or group), and provide information about the user which allows the system to provide a wider range of verbal functionality. Identification characteristics of each individual (e.g., image and facial recognition) can be considered to be contained in the preference settings, or alternatively within a separate database. It should be appreciated, that databases can be merged or separated in any desired manner without departing from the teachings of the present invention.

It will be noted that although a group is a collection of individuals, the preference settings provide for generating different verbal outputs when addressing an arbitrary group, or a select group. For example, the persons in a household, although having individual preference settings, could be addressed by a group preference setting when more than one are present, or in response to the presence of specific persons from the group.

Preference settings can allow the user to select many aspects of the verbal communication, for example: extent of verbalizations, voice (e.g., male/female, voice quality, intonation, accent, language (e.g., English, German, Spanish, French, etc.), sub-language (Kings English, American English, Southern Drawl, Creole, etc.), subject areas for interaction (e.g., users favorite shows, favorite types of shows, and show topics, cast of characters and background information, filming information, weather, current events, local news, and so forth). It will be appreciated that the word “show” is utilized above in its broadest sense to indicate any selectable piece of television content, including a movie, one program segment of a running series, a documentary, a news program, a cartoon, and so forth.

When entering preference settings, the user can also provide information about their specific likes and dislikes, for example, what are their favorite types of shows (e.g., type (movie, situation comedy, reality show, etc.) genre (classic, detective, western, horror, romance, etc.), length, favorite viewing times, and so forth. From this information the system can more readily decide what verbal information is of interest to the user, and suggest shows, provide background information on shows, and to provide information about other subjects, such as the weather, news, and so forth by obtaining additional information over a communications channel, for instance Internet connection 32. It will be appreciated that the above categories are provided by way of example and not limitation, as the system can be readily configured to allow interaction in any one or more topic areas without restriction.

Once preference settings are established, then the television is capable of using image/facial recognition to identify individuals and has a cue as to what types and extent of verbal output to generate. It will be noted, however, that modes of the invention can generate default levels of verbal annunciations without preference settings, and can request that the user identifies themselves (verbally if device is speech recognition equipped, or by text entry, or otherwise). In this way the system can without limitation obtain information “on-the-fly” to increase the utility of the verbal communication.

The television then captures imaging (e.g., stills or video) 52 of the individuals proximal the device, and performs image/facial recognition 54 with respect to a database of characteristics to determine which individuals are present, and if multiple persons are present do they define a group for which additional information is available. Verbal parameters and customization information for these individuals and groups is retrieved 56 and made available for generating the verbal outputs. An optional step 58, as indicated by an asterisk in FIG. 2, illustrates that in at least one embodiment, the television can be configured with at least one microphone and associated programming for speech recognition to register verbal input 58, such as commands and responses, from the individuals which are proximal and/or viewing the television.

The system may optionally (as marked with an asterisk in the figure) retrieve additional information 60, such as relating to the preference information from the individuals and their respective viewing history, through a communications connection, exemplified as a wide area network 32 shown in FIG. 1. Verbal communication/annunciations are then generated 62 by the programming and directed to individuals and/or groups thereof, which can be output on the fly, or optionally (as marked with an asterisk in the figure) output in response to detection of media breaks 64 so that the verbal annunciations are output at an appropriate time to minimize interrupting the viewers experience. For example, in at least one mode of the invention, the audio output from the program source is muted during the annunciations, such as muting the audio of a televised commercial break and outputting the audio. In another example, the programming is configured to recognize when the user is not paying attention to the televised programming, such as in response to their fleeting presence and optionally based on their own conversation or generated noise (e.g., talking, moving about, preparing a snack in the adjacent kitchen, and so forth). In one mode of the invention, if the programming source can be paused (e.g., from a media source (DVD, DVR, or other storage or pausible media), then the playback can be paused for verbal output messages which are considered of sufficient importance.

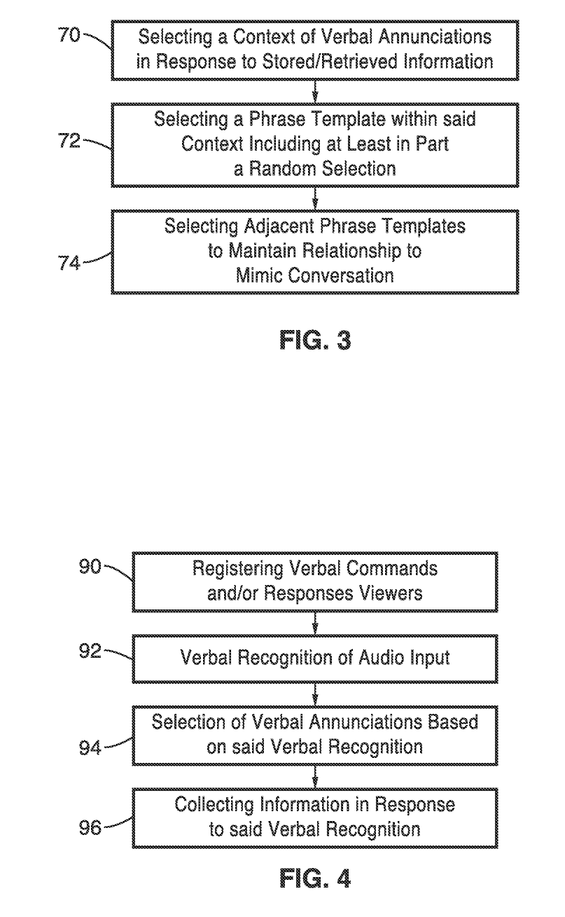

FIG. 3 illustrates an example embodiment in which verbal annunciations are generated in response to a “context” and “template”, to provide a conversational output which is not too predictable, including assuring that the given “context” and phrasing has not been recently utilized. A context is first selected 70, which can be considered the “subject”, but in a sense in which it is connected with prior verbal output and can be finely divided. Examples of context may include: television shows of possible interest which are playing today, today's local temperatures/precipitation, storm warnings, news alerts, cast and background information about favorite shows, and a wide range of topics and sub-topics which are only limited in regard to the extent of information made available to the system and nexus with how this fits the preferences of the user (e.g., do they want to hear about the weather, or these other categories of information).

Within the verbal context “phrase templates” are then selected 72 with some random contribution, while connecting to the previous phrase outputs. For example, one context could be the weather, wherein a phrase template is selected and filled-in regarding temperature, such as: “John—it's really warming up today, . . . should reach 85 degrees”. The actual high temperature of “85” is obtained from an outside data source, such as through an internet connection, and used to fill-in the phrasing template. This verbal output could then also be tied in by selecting subsequent phrasing 74 within this context to mimic the smooth flow of a conventional verbal conversation. In the above example of a weather context, additional information, such as forecasts, historical trends and so forth, could be output in subsequent phrase templates; with the selection having a randomized input and with the system preventing the selection of phrasing which has been recently used, and assuring that the system is not unduly repeating the same contexts. In an extended mode, information could be verbalized about other locations or areas, for instance weather, news and so forth in the non-local area as stipulated in the preference setting; such as that of family members.

In one embodiment of the invention chatter heuristics can be parameterized in response to (a) “user statistics”, such as, for example, name(s), location, purchase history, user interests other information as desired; (b) “viewing history”; and (c) “cooperative information” in which information is collected based on the above parameters for use in “phrase templates”. Optimally, this information can be collected through a web connection to provide the data for filling in appropriate “phrase templates”.

FIG. 4 illustrates a method of registering viewer gestures and/or speech input by the system toward optimizing verbal output. In these optional embodiments, the verbal outputs of the television are at least partially responsive to registration of user input in the form of gestures and/or speech recognition. It will be appreciated that gesture recognition can be performed using information captured from the camera, if configured to provide a sufficient framing rate, and processed according to known techniques for determining gestures within image recognition programming. The recognition of speech input requires utilizing speech recognition programming on audio captured by the television, such as through microphone 30 shown in FIG. 1.

By way of example and not limitation gestures can comprise any desired association between gesture and command, such as defining a horizontal karate-chop like hand motion as a command for the television to reduce its chatter mode, or other gestures without limitation to control other aspects of the chatter.

Similar to the above, various commands and controls can be executed by the system in response to the recognition of the user's speech, as exemplified in FIG. 4. Using speech recognition, specific user control words are received through the microphone and speech recognition performed to convert the audio to text. To simplify the recognition process, key phrases can be utilized to frame requests from the user. The system could even be trained (e.g., user voices the specific phrase elements) by a specific user to increase accuracy. Verbal audio data is first captured 90. It will be appreciated that the system preferably must first determine the difference between noises and speech input. The system ignores (filters out) audio from what is being televised so that this material would not be considered audio input. In addition, the unit preferably is configured toward discerning output from other audio sources, such as radio programming, from that of the user.

Verbal recognition is performed 92 to discern the command information from the user. This command information is then used 94 to modify the user preferences for this particular individual, or change the verbal context characteristics (e.g., subject, output characteristics, etc.), leading to selection of verbal annunciations based on the verbal recognition. Depending on the meaning assigned to the verbal recognition, additional information can be optionally collected 96, prior to or after generating the above verbal annunciation.

It should be appreciated that speech recognition can also be utilized according to the invention for the user to tell the system of desired information which can be fulfilled and output as verbal system output, or for posting reminders (e.g., important dates, birthdays, things to do and so forth), fulfilling user requests for information and so forth. It should be noted that although FIG. 4 is directed to speech input, gesture recognition can follow the same basic flow wherein a separate flowchart is not provided.

The present invention provides methods and apparatus for verbal communications from a television set, that can be implemented with a wide range of optional modes and embodiments.

As can be seen, therefore, the present invention includes the following inventive embodiments among others:

1. A television apparatus, comprising: means for displaying video images of received media programming; means for generating an audio output; means for collecting user input; means for capturing images of areas proximal said apparatus as captured images; means for controlling said displaying of video images and said generating of audio output in response to input from said means for collecting user input and said means for capturing images; and means for generating personalized verbal output in response to performing image and/or facial recognition on said captured images to identify individuals viewing and/or interacting with said television apparatus and retrieve associated stored preferences that are utilized in generating personalized verbal output from said apparatus.

2. The apparatus recited in embodiment 1, wherein said means for registering user input registers user input from sources selected from the group of sources consisting of tactile-interface input from wired or wireless user interfaces, gesture recognition, and speech recognition.

3. A television apparatus, comprising: a display subsystem configured for displaying video images; an audio output subsystem; user interface configured for user selection of media programming and operating characteristics of said television apparatus; a camera subsystem; a computer configured for controlling said display subsystem and said audio subsystem in response to input from said user interface and said camera subsystem; and programming executable on the computer for: controlling said camera subsystem for capturing images of individuals viewing and/or interacting with said television apparatus; performing facial recognition against a database to determine what individual, or individuals, are viewing and/or interacting with said television apparatus; retrieving stored information about said individual, or individuals, which are viewing and/or interacting with said television apparatus; and generating verbal annunciations based on retrieval of said stored information when said individual, or individuals are viewing and/or interacting with said television apparatus.

4. The apparatus recited in embodiment 3, further comprising programming executable on the computer for storing information regarding television preferences for each of said individual, or individuals, which are viewing and/or interacting with said television apparatus.

5. The apparatus recited in embodiment 3, further comprising programming executable on the computer for selecting a default verbal annunciation mode when viewers are not recognized by said apparatus.

6. The apparatus recited in embodiment 3, further comprising programming executable on the computer for retrieving information for use in said verbal annunciations through a wide area network connection in operative communication with said apparatus.

7. The apparatus recited in embodiment 6, wherein said information is selected from the group of information consisting of media program information, weather information, news, and historical information.

8. The apparatus recited in embodiment 3, wherein said preferences are determined for at least one individual viewer of said apparatus as selected from the group of preferences consisting of favorite channels, favorite shows, viewing history, display settings, audio settings, and viewing times.

9. The apparatus recited in embodiment 3, further comprising programming executable on the computer for detecting commercial or programming breaks in the media being played by said apparatus, and generating said verbal annunciations during those breaks.

10. The apparatus recited in embodiment 3: wherein a context of said verbal annunciations are selected in response to said stored information; and wherein within said context a phrase template is selected based at least in part on random selection.

11. The apparatus recited in embodiment 3 further comprising programming executable on the computer for selecting adjacent phrase templates which maintain a relationship to one another and thus mimic phrases in a conversation.

12. The apparatus recited in embodiment 3, further comprising: a microphone; and programming executable on the computer for performing speech recognition on the output from said microphone for controlling selection of verbal annunciations from said apparatus, and/or registering verbal commands from said at least one individual.

13. The apparatus recited in embodiment 12, wherein speech recognition is configured for controlling and/or determining selection of verbal annunciations from said apparatus.

14. A television apparatus, comprising: a display subsystem configured for displaying video images; an audio output subsystem; user interface configured for user selection of media programming and operating characteristics of said television apparatus; a camera subsystem; a computer configured for controlling said display subsystem and said audio subsystem in response to input from said user interface and said camera subsystem; programming executable on the computer for: storing information regarding television preferences for individuals viewing and/or interacting with said television apparatus; controlling said camera subsystem for capturing images of individuals viewing and/or interacting with said television apparatus; performing facial recognition against a database to determine what individual, or individuals, are viewing and/or interacting with said television apparatus; retrieving stored information about said individual, or individuals, which are viewing and/or interacting with said television apparatus; and generating verbal annunciations based on retrieval of said stored information when said individual, or individuals are viewing and/or interacting with said television apparatus.

15. The apparatus recited in embodiment 14, further comprising programming executable on the computer for selecting a default verbal annunciation mode when one of said individual is not recognized by said apparatus.

16. The apparatus recited in embodiment 14, further comprising programming executable on the computer for retrieving information for use in said verbal annunciations through a wide area network connection in operative communication with said apparatus.

17. The apparatus recited in embodiment 14, wherein said information is selected from the group of information consisting of media program information, weather information, news, and historical information.

18. The apparatus recited in embodiment 14, wherein said preferences are determined for at least one individual viewer of said apparatus as selected from the group of preferences consisting of favorite channels, favorite shows, viewing history, display settings, audio settings, and viewing times.

19. The apparatus recited in embodiment 14, further comprising programming executable on the computer for detecting commercial or programming breaks in the media being played by said apparatus, and generating said verbal annunciations during those breaks.

20. The apparatus recited in embodiment 14, further comprising: a microphone; and programming executable on the computer for performing speech recognition on the output from said microphone for controlling selection of verbal annunciations from said apparatus, and/or registering verbal commands from said at least one individual.

Another embodiment of the invention is a television which verbally and personally communicates with specific individuals and/or groups in response to image recognition, and in particular facial recognition.

Another embodiment of the invention is a television set having at least one camera (e.g., coupled to, or more preferably integrated with, the television) for capturing images proximal to the television, and more particularly the area in front of the screen from which the television is normally viewed.

Another embodiment of the invention is a television which provides the ability to generate conversational verbal annunciations responsive to individual viewers, or groups thereof.

Another embodiment of the invention is a television which stores verbal communication preferences for individual viewers which utilize the television, and can select default verbal communications mode for unidentified viewers based on their viewing history.

Another embodiment of the invention is a television which generates verbal output to individual users in a conversational manner, having a topic (context) within which inter-related phrase templates are populated and utilized.

Another embodiment of the invention is a television which generates verbal output that is not repetitive, predictable, or monotonous.

Another embodiment of the invention is a television which provides information to identified users according to their preference selections, and optionally in response to inputs (e.g., verbal and/or gesture) from the user.

Another embodiment of the invention is a television which automatically provides information to the user which extends beyond the status of the television, such as electronic information obtained about items of interest selected by the user (e.g., show information, weather (local and user selected areas), news, and similar themed information).

A still further embodiment of the invention is a television which can operate conventionally, or utilizing the verbal communications.

Embodiments of the present invention may be described with reference to flowchart illustrations of methods and systems according to embodiments of the invention, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula (e), or computational depiction(s).

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A television apparatus, comprising:
means for displaying video images of received media programming;
means for generating an audio output;
means for collecting user input;
means for capturing images of areas proximal said apparatus as captured images;
means for controlling said displaying of video images and said generating of audio output in response to input from said means for collecting user input and said means for capturing images; and
means for generating personalized verbal output in response to performing image and/or facial recognition on said captured images to identify individuals viewing and/or interacting with said television apparatus and retrieve associated stored preferences that are utilized in generating personalized verbal output from said apparatus.

2. The apparatus recited in claim 1, wherein said means for registering user input registers user input from sources selected from the group of sources consisting of tactile-interface input from wired or wireless user interfaces, gesture recognition, and speech recognition.

3. A television apparatus, comprising:
a display subsystem configured for displaying video images;
an audio output subsystem;
user interface configured for user selection of media programming and operating characteristics of said television apparatus;
a camera subsystem;
a computer configured for controlling said display subsystem and said audio subsystem in response to input from said user interface and said camera subsystem; and
programming executable on the computer for:
controlling said camera subsystem for capturing images of individuals viewing and/or interacting with said television apparatus;
performing facial recognition against a database to determine what individual, or individuals, are viewing and/or interacting with said television apparatus;
retrieving stored information about said individual, or individuals, which are viewing and/or interacting with said television apparatus; and
generating verbal annunciations based on retrieval of said stored information when said individual, or individuals are viewing and/or interacting with said television apparatus.

4. The apparatus recited in claim 3, further comprising programming executable on the computer for storing information regarding television preferences for each of said individual, or individuals, which are viewing and/or interacting with said television apparatus.

5. The apparatus recited in claim 3, further comprising programming executable on the computer for selecting a default verbal annunciation mode when viewers are not recognized by said apparatus.

6. The apparatus recited in claim 3, further comprising programming executable on the computer for retrieving information for use in said verbal annunciations through a wide area network connection in operative communication with said apparatus.

7. The apparatus recited in claim 6, wherein said information is selected from the group of information consisting of media program information, weather information, news, and historical information.

8. The apparatus recited in claim 3, wherein said preferences are determined for at least one individual viewer of said apparatus as selected from the group of preferences consisting of favorite channels, favorite shows, viewing history, display settings, audio settings, and viewing times.

9. The apparatus recited in claim 3, further comprising programming executable on the computer for detecting commercial or programming breaks in the media being played by said apparatus, and generating said verbal annunciations during those breaks.

10. The apparatus recited in claim 3:
wherein a context of said verbal annunciations are selected in response to said stored information; and
wherein within said context a phrase template is selected based at least in part on random selection.

11. The apparatus recited in claim 3, further comprising programming executable on the computer for selecting adjacent phrase templates which maintain a relationship to one another and thus mimic phrases in a conversation.

12. The apparatus recited in claim 3, further comprising:
a microphone; and
further comprising programming executable on the computer for performing speech recognition on the output from said microphone for controlling selection of verbal annunciations from said apparatus, and/or registering verbal commands from said at least one individual.

13. The apparatus recited in claim 12, wherein speech recognition is configured for controlling and/or determining selection of verbal annunciations from said apparatus.

14. A television apparatus, comprising:
a display subsystem configured for displaying video images;
an audio output subsystem;
user interface configured for user selection of media programming and operating characteristics of said television apparatus;
a camera subsystem;
a computer configured for controlling said display subsystem and said audio subsystem in response to input from said user interface and said camera subsystem;
programming executable on the computer for:
storing information regarding television preferences for individuals viewing and/or interacting with said television apparatus;
controlling said camera subsystem for capturing images of individuals viewing and/or interacting with said television apparatus;
performing facial recognition against a database to determine what individual, or individuals, are viewing and/or interacting with said television apparatus;
retrieving stored information about said individual, or individuals, which are viewing and/or interacting with said television apparatus; and
generating verbal annunciations based on retrieval of said stored information when said individual, or individuals are viewing and/or interacting with said television apparatus.

15. The apparatus recited in claim 14, further comprising programming executable on the computer for selecting a default verbal annunciation mode when one of said individual is not recognized by said apparatus.

16. The apparatus recited in claim 14, further comprising programming executable on the computer for retrieving information for use in said verbal annunciations through a wide area network connection in operative communication with said apparatus.

17. The apparatus recited in claim 14, wherein said information is selected from the group of information consisting of media program information, weather information, news, and historical information.

18. The apparatus recited in claim 14, wherein said preferences are determined for at least one individual viewer of said apparatus as selected from the group of preferences consisting of favorite channels, favorite shows, viewing history, display settings, audio settings, and viewing times.

19. The apparatus recited in claim 14, further comprising programming executable on the computer for detecting commercial or programming breaks in the media being played by said apparatus, and generating said verbal annunciations during those breaks.

20. The apparatus recited in claim 14, further comprising:
a microphone; and
programming executable on the computer for performing speech recognition on the output from said microphone for controlling selection of verbal annunciations from said apparatus, and/or registering verbal commands from said at least one individual.
